(19) United States
(12) Patent Application Publication
(10) Pub. No.: US 2007/0211390 A1
(43) Pub. Date: Sep. 13, 2007

(54) Piezoelectric actuator and magnetic disk device

(75) Inventors: Tamotsu Yamamoto, Kawasaki (JP); Masaharu Hida, Kawasaki (JP); Shigeyoshi Umemiya, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/476,855

(22) Filed: Jun. 29, 2006

(30) Foreign Application Priority Data
Mar. 8, 2006 (JP) 2006-063282

(51) Int. Cl. G11B 21/24

(52) U.S. Cl. 360/294.4

(57) ABSTRACT

One surface of a piezoelectric actuator is bonded to a suspension via bonding agents. The piezoelectric actuator is bonded to the suspension at two positions sandwiching a coupling portion therebetween. Namely, the bonding is performed at respective one end portions of two piezoelectric active portions, and these end portions are situated on opposite sides with respect to the coupling portion. In the bonding, since the two piezoelectric active portions are integrated via the coupling portion, relative position adjustment between the piezoelectric active portions is very easy. Further, the number of terminals to connect with a wiring pattern formed on the suspension is only two, and the suspension need not be rotated 180 degrees at the time of bonding, so that the time required for bonding is short.

### CROSS-REFERENCE TO RELATED APPLICATIONS

This application is based upon and claims the benefit of priority from the prior Japanese Patent Application No. 2006-063282, filed on Mar. 8, 2006, the entire contents of which are incorporated herein by reference.

### BACKGROUND OF THE INVENTION

1. Field of the Invention

The present invention relates to a piezoelectric actuator and a magnetic disk device suitable for fine position control.

2. Description of the Related Art

In recent years, a demand for recording large-volume data such as a moving image and a music on a hard disk drive mounted as a storage device of a personal computer has been increasing and hence a recording density has been being rapidly improved. The hard disk drive includes a magnetic disk, which is a recording medium, and a magnetic head, which reads and writes recording bits from and to the magnetic disk. The hard disk drive further includes a swing arm, which brings the magnetic head close to the magnetic disk and holds the magnetic head, and an electromagnetic type actuator, which moves the magnetic head along the magnetic disk by driving the swing arm. The magnetic head is fixed to a head slider, and a head suspension extending from a tip of the swing arm is provided between the swing arm and the magnetic head. A microactuator which changes a posture of the head slider relative to the head suspension is provided between the head slider and the head suspension.

To improve the recording density, scale down of a recording bit is required, and a technology to improve a positioning accuracy of the magnetic head capable of meeting the requirement is indispensable. Hence, for example, in Patent Document 1, a head assembly using piezoelectric actuators as a microactuator is disclosed. In the head assembly described in Patent Document 1, two piezoelectric actuators which extend parallel to each other are provided. End portions on the same side of the two piezoelectric actuators are fixed to one fixing piece, and the other end portions are fixed to another fixing piece. The one fixing piece is bonded to a head suspension, and the other fixing piece is bonded to a head slider.

In such a head assembly, with the extension and contraction of the piezoelectric actuators, the head slider swingingly moves around a bonded portion between the piezoelectric actuators and the head suspension. Namely, the head slider is slightly displaced, for example, in a radial direction of a magnetic disk. As a result, it becomes possible that the magnetic head attached to the head slider continues following a recording track on the magnetic disk with high accuracy.

However, in that structure, the resonant frequency of a vibration system including the head slider and the piezoelectric actuators is low. Since position control at a frequency higher than the resonant frequency cannot be performed, an improvement in position accuracy is not sufficient.

Hence, a head assembly capable of increasing the resonant frequency is developed (Patent Document 2). As shown in FIG. 14 and FIG. 15, the head assembly described in Patent Document 2 is provided with two piezoelectric actuators 153 which extend parallel to each other, and end portions bonded to a suspension 151 and a slider 152 are different. Namely, at one end portions, one piezoelectric actuator 153 is bonded to the suspension 151 via a bonding agent 154, and the other piezoelectric actuator 153 is bonded to the slider 152 via a bonding agent 155. Therefore, a high resonant frequency is obtained.

However, to control a position of a magnetic head 156 attached to the slider 152 with high accuracy in such a head assembly, it is required to assemble the two piezoelectric actuators 153, the slider 152, and the suspension 151 with high accuracy. The following method is given as a high-accuracy assembly method. First, the two piezoelectric actuators 153 is fixed to a jig and bonded to the suspension 151, and then the jig is detached. Subsequently, the slider 152 is bonded to the piezoelectric actuators 153. However, since the size of the piezoelectric actuators 153 is small, in that method, it is troublesome to attach the two piezoelectric actuators 153 to the jig with high position accuracy, and consequently the time required for the operation becomes long.

Moreover, in the head assembly described in Patent Document 2, the two piezoelectric actuators 153 are each provided with two terminals 157 and 158 since they need to be driven individually, and the terminals 157 and 158 need to be connected to a wiring pattern extending along the surface of the suspension 151. However, in the two piezoelectric actuators 153, portions bonded to the suspension 151 are located at end portions on opposite sides (at positions displaced 180 degrees with respect to the center of rotation). Therefore, in the bonding operation, it is necessary to bond the terminal of one piezoelectric actuator 153, thereafter rotate the suspension 151 by 180 degrees, and bond the terminal of the other piezoelectric actuator 153. There is a demand for a reduction in the time required for such an operation.

Related arts are disclosed in Patent Document 1 (Japanese Patent application Laid-open No. Hei 11-273041), Patent Document 2 (Japanese Patent application Laid-open No. 2003-123416), Patent Document 3 (International Publication No. 00/30080), Patent Document 4 (Japanese Patent Application Laid-open No. 2003-284362), Patent Document 5 (Japanese Patent Application Laid-open No. 2003-61370), and Patent Document 6 (International Publication No. 02/35695).

### SUMMARY OF THE INVENTION

An object of the present invention is to provide a piezoelectric actuator and a magnetic disk device capable of fine position control and simultaneously facilitating an assembly operation of the magnetic disk device.

In a piezoelectric actuator according to the present invention, a first and second piezoelectric active portions which extend parallel to each other are provided. The first and second piezoelectric active portions are integrated, each being constructed by alternately stacking first electrode layers connected in common and second electrode layers connected in common with an active layer therebetween.

In a magnetic disk device according to the present invention, a suspension, a piezoelectric actuator attached to the suspension, a slider attached to the piezoelectric actuator, and a magnetic head attached to the slider are provided. The piezoelectric actuator includes a first and second piezoelectric active portions which extend parallel to each other. The first and second piezoelectric active portions are integrated, each being constructed by alternately stacking first electrode layers connected in common and second electrode layers connected in common with an active layer therebetween.

### BRIEF DESCRIPTION OF THE DRAWINGS

FIG. 1 is a view showing an internal structure of a hard disk drive (HDD) according to an embodiment of the present invention;

FIG. 2A is a plan view showing a manufacturing method of a piezoelectric actuator according to the embodiment of the present invention;

FIG. 2B is a plan view similarly showing the manufacturing method of the piezoelectric actuator according to the embodiment of the present invention;

FIG. 3 is an exploded perspective view following FIG. 2A and FIG. 2B, showing the manufacturing method of the piezoelectric actuator;

FIG. 4 to FIG. 8 are plan views following FIG. 3, showing the manufacturing method of the piezoelectric actuator step by step;

FIG. 9A is a view showing a pattern of an electrode layer 12 in the piezoelectric actuator;

FIG. 9B is a view showing a pattern of an electrode layer 22 in the piezoelectric actuator;

FIG. 10 is an exploded perspective view showing an example of a head assembly according to the embodiment of the present invention;

FIG. 11 is a view showing a positional relationship between a piezoelectric actuator 53 and a suspension 51;

FIG. 12 is a view showing an example of a planar shape of the piezoelectric actuator;

FIG. 13 is a view showing another example of the planar shape of the piezoelectric actuator;

FIG. 14 is an exploded perspective view showing an example of a conventional head assembly; and

FIG. 15 is a view showing a positional relationship between piezoelectric actuators 153 and a suspension 151.

### DETAILED DESCRIPTION OF THE PREFERRED EMBODIMENTS

An embodiment of the present invention will be specifically described below with reference to the attached drawings.

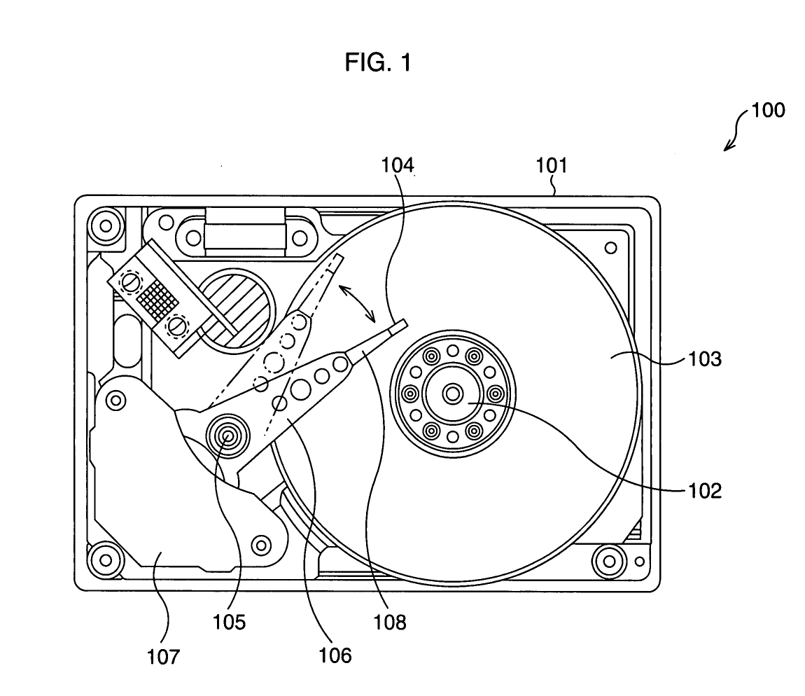

First, a hard disk drive will be described as an example of a magnetic disk device according to the embodiment of the present invention. FIG. 1 is a view showing an internal structure of the hard disk drive (HDD) according to the embodiment of the present invention.

In a housing 101 of the hard disk drive 100, a magnetic disk 103 which is attached to a rotating shaft 102 and rotates, a slider 104 equipped with a magnetic head which records information onto and reproduces information from the magnetic disk 103, a suspension 108 which holds the slider 104, a carriage arm 106 to which the suspension 108 is fixed and which moves around an arm shaft 105 along the surface of the magnetic disk 103, and an arm actuator 107 which drives the carriage arm 106 are housed. Although not shown in FIG. 1, a piezoelectric actuator described below is provided between the slider 104 and the suspension 108.

Next, the piezoelectric actuator according to the embodiment of the present invention will be described. Note here that, for convenience, the structure of the piezoelectric actuator is described with a manufacturing method thereof.

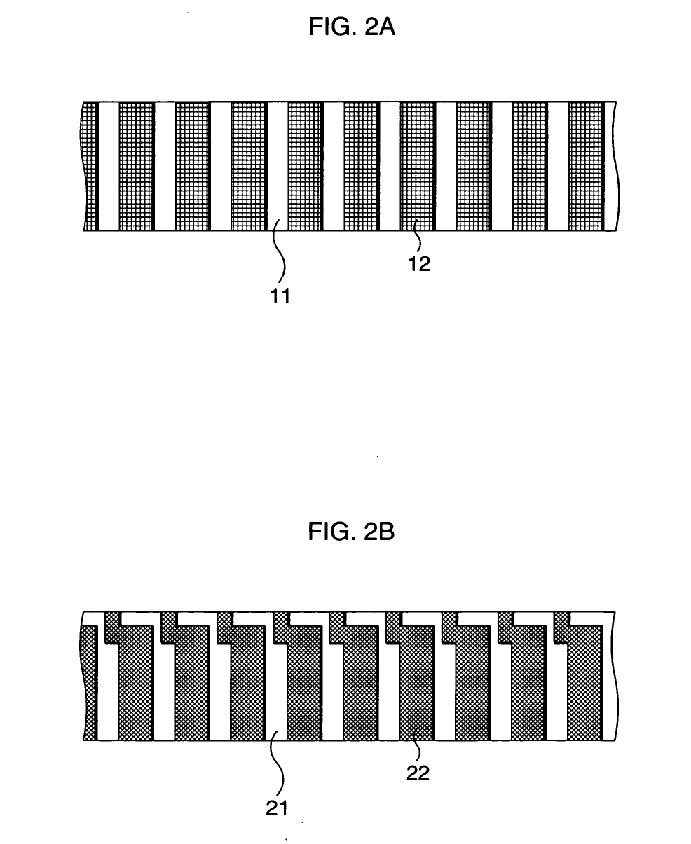

In the present embodiment, first, as shown in FIG. 2A, electrode layers 12 are selectively formed all over a green sheet (piezoelectric ceramic layer) 11. For example, a green sheet containing PbNi_{1/3}Nb_{2/3}O₃ powder, PbTiO₃ powder, and PbZrO₃ powder is used as the green sheet 11. The thickness of the green sheet 11 is, for example, about 20 μm to 30 μm. In forming the electrode layers 12, for example, a Pt paste is screen-printed. Incidentally, preferably, the Pt paste contains approximately 5 vol % to 50 vol % of PbNi_{1/3}Nb_{2/3}O₃ powder, PbTiO₃ powder, and PbZrO₃ powder in total, and more preferably, it contains approximately 10 vol % to 30 vol % thereof. For example, it contains approximately 20 vol % thereof. This is for the purpose of ensuring high adhesion with the green sheet 11. However, if conductivity can be ensured, it may contain a larger quantity of powder, and if it is necessary to ensure higher conductivity, it may contain a smaller quantity of powder. If the powder content exceeds an upper limit of the above numerical range, the conductivity may become too low, and if it is less than a lower limit thereof, sufficient adhesion may not be obtained.

Similarly, as shown in FIG. 2B, electrode layers 22 are selectively formed on a green sheet 21. As the green sheet 21, for example, the same green sheet as the green sheet 11 is used. Moreover, the electrode layers 22 are formed, for example, using the same material by the same method as the electrode layers 12.

Note that patterns of the electrode layers 12 and 22 are not particularly limited. For example, the pattern of the electrode layer 12 is a rectangle such as shown in FIG. 2A. As shown in FIG. 2B, the pattern of the electrode layer 22 is different from the pattern of the electrode layer 12 in a lead-out portion to the outside near one side.

Incidentally, the formation of the electrode layers 22 on the green sheet 21 may be performed before the formation of the electrode layers 12 on the green sheet 11.

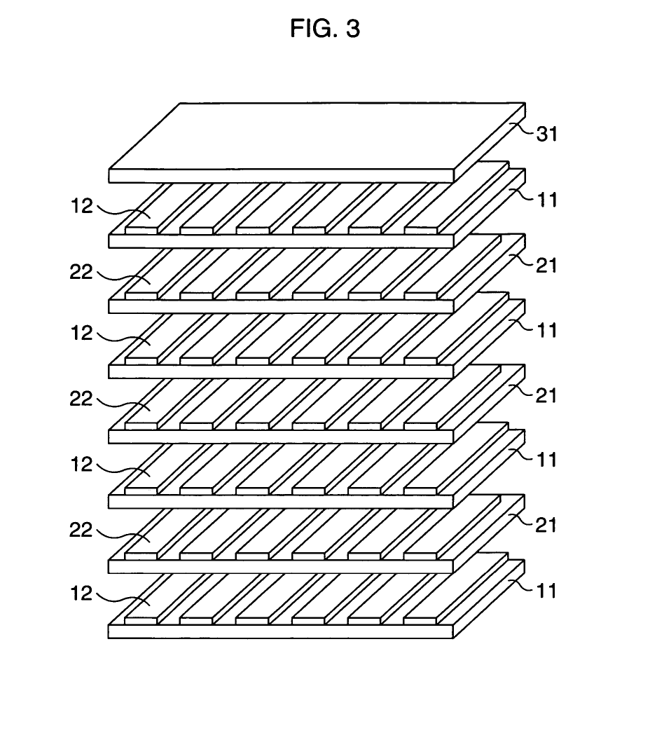

Then, as shown in FIG. 3, a total of seven of the green sheets 11, on each of which the electrode layers 12 are formed, and the green sheets 21, on each of which the electrode layers 22 are formed, are alternately stacked, and a green sheet 31 is further stacked on the uppermost portion. As the green sheet 31, for example, the same green sheet as the green sheets 11 and 21 is used. Subsequently, by performing degreasing treatment in the atmosphere, organic constituents contained in the green sheets 11, 21 and 31 are removed.

Thereafter, by burning in the atmosphere, a stacked body 32 into which the green sheets and the electrode layers are integrated is obtained. Then, as shown in FIG. 4, by punching the stacked body 32, rectangular openings 33 are formed at even intervals. At this time, positions at which the openings 33 are formed, for example, are matched with gaps between the electrode layers 12 and gaps between the electrode layers 22, and the electrode layers 12 and 22 are left between the adjacent openings 33.

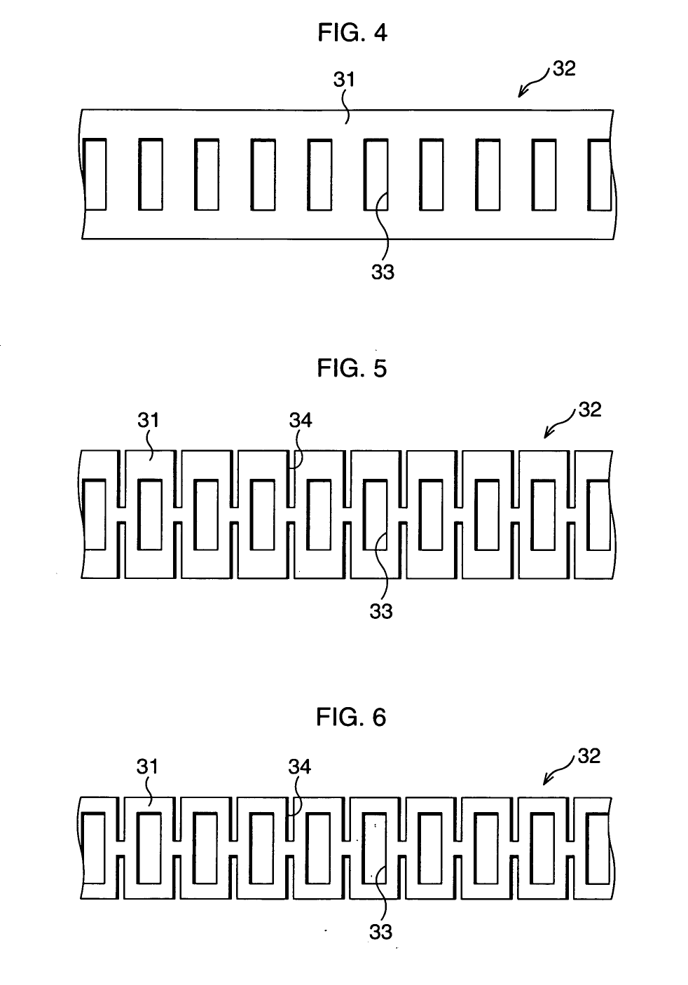

Subsequently, as shown in FIG. 5, in intermediate positions between the adjacent openings 33, cutouts 34 extending in a width direction from both sides of the stacked body 32 are formed with a dicing saw or the like. As a result, the stacked body 32 is partitioned into plural rectangular regions by the cutouts 34, and respective regions are coupled by portions located between the cutouts 34 facing each other.

Thereafter, as shown in FIG. 6, the width of the stacked body 32 is matched with the length of the piezoelectric actuator to be formed by cutting both sides of the stacked body 32 along a longitudinal direction.

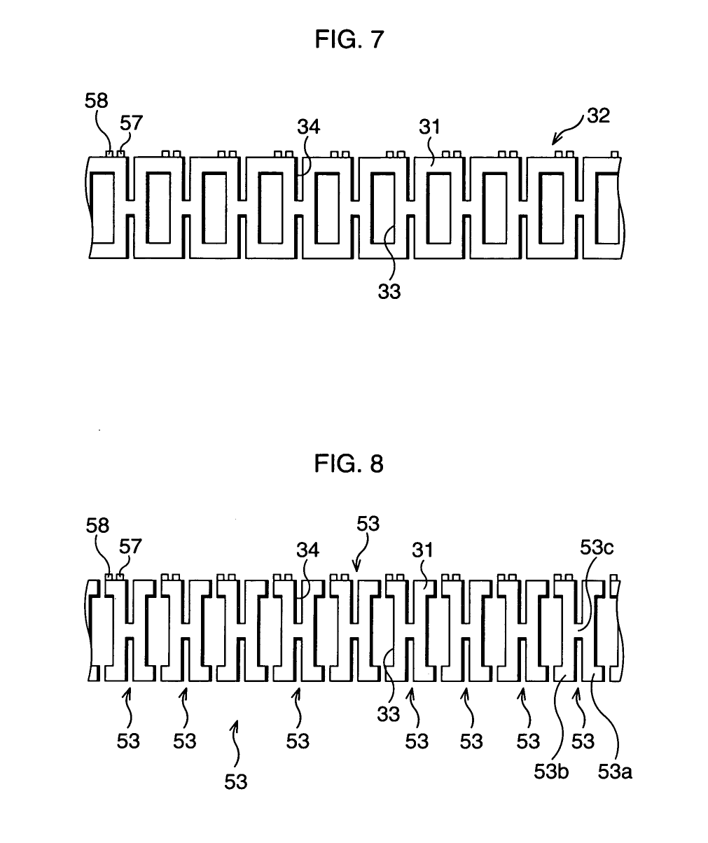

Then, as shown in FIG. 7, terminals 57 and 58 are formed in respective regions partitioned by the cutouts 34. At this time, the terminals 57 are formed to be connected to respective electrode layers 12, and the terminals 58 are formed to be connected to respective electrode layers 22. The terminals 57 and 58 are formed only on one side of the stacked body 32. Moreover, the positions of the terminals 57 and 58 are biased to one cutout 34 side in regions partitioned by the cutouts 34. The terminals 57 and 58 can be formed, for example, by a sputtering method, a deposition method, or the like.

Subsequently, as shown in FIG. 8, by separating the regions partitioned by the cutouts 34 in the width direction from both sides of the stacked body 32 from one another, plural piezoelectric actuators 53 are cut out from the stacked body 32. In the piezoelectric actuator 53, two piezoelectric active portions 53a and 53b which extend in the width direction of the stacked body 32 and a coupling portion 53c which couples the piezoelectric active portions 53a and 53b exist. Namely, the piezoelectric actuator 53 into which the two piezoelectric active portions 53a and 53b are integrated is obtained. The overall planar shape is substantially an “H” shape.

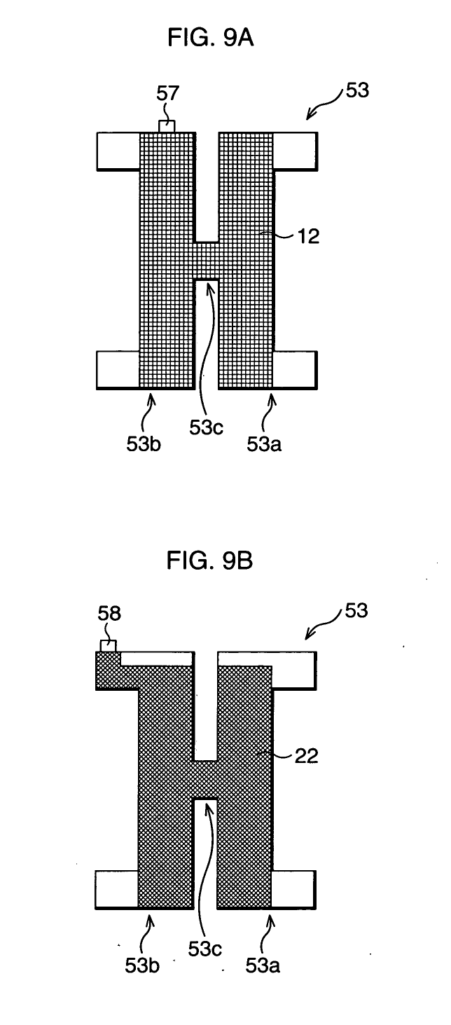

In the piezoelectric actuator 53, respective patterns of the electrode layers 12 and 22 are such as shown in FIG. 9A and FIG. 9B. Namely, in the electrode layer 12, portions which match the piezoelectric active portions 53a and 53b and a portion which matches the coupling portion 53c exist. The terminal 57 is connected to an end of the portion which matches the piezoelectric active portion 53b. On the other hand, in the electrode layer 22, a portion which matches the piezoelectric active portion 53a and a portion which matches the coupling portion 53c exist, and further a portion which mostly matches the piezoelectric active portion 53b and in which a lead-out portion to the terminal 58 is formed exists.

In the piezoelectric actuator 53 manufactured by this method, a portion sandwiched between the electrode layers 12 and 22 functions as an active layer. With the application of a voltage to the terminals 57 and 58, the active layers in the piezoelectric active portions 53a and 53b contract in the longitudinal direction. The coupling portion 53c also contracts slightly, but the amount of the contraction is very small and negligible as compared with the piezoelectric active portions 53a and 53b.

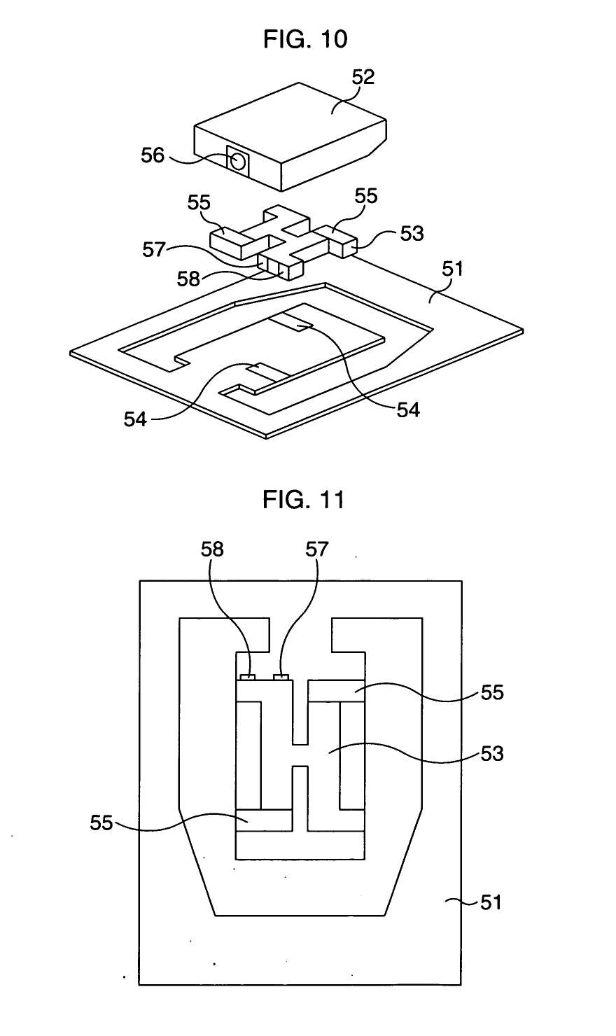

Next, a head assembly of a hard disk drive including the above-described piezoelectric actuator will be described. FIG. 10 is an exploded perspective view showing an example of the head assembly. FIG. 11 is a view showing a positional relationship between the piezoelectric actuator 53 and a suspension 51.

As shown in FIG. 10, in the head assembly, the piezoelectric actuator 53 according to the above embodiment is used. One surface of the piezoelectric actuator 53 is bonded to the suspension 51 via bonding agents 54. Incidentally, the piezoelectric actuator 53 is bonded to the suspension 51 at two positions sandwiching the coupling portion 53c therebetween. Namely, the bonding is performed at respective one end portions of the piezoelectric active portion 53a and the piezoelectric active portion 53b, and these end portions are situated on opposite sides with respect to the coupling portion 53c. In the bonding, since the piezoelectric active portions 53a and 53 are integrated via the coupling portion 53c, relative position adjustment between the piezoelectric active portions 53a and 53b is very easy. Further, as shown in FIG. 10 and FIG. 11, the number of terminals to connect with a wiring pattern formed on the suspension 51 is only two (terminals 57 and 58), and the suspension 51 need not be rotated 180 degrees at the time of bonding, so that the time required for bonding can be greatly shortened as compared with that in related arts.

Furthermore, a slider 52 to which a magnetic head 56 is attached is bonded to the other surface of the piezoelectric actuator 53 via bonding agents 55. Incidentally, the piezoelectric actuator 53 is bonded to the slider 52 at two positions sandwiching the coupling portion 53c therebetween. Note, however, that the bonding is performed at end portions of the piezoelectric active portions 53a and 53b on the sides opposite to the end portions where the piezoelectric actuator 53 is bonded to the suspension 51.

Incidentally, the suspension 51 corresponds to the suspension 108 in FIG. 1, and the slider 52 corresponds to the slider 104 in FIG. 1.

In the head assembly thus constructed, when no voltage is applied to the piezoelectric actuator 53, the piezoelectric active portions 53a and 53b are in a linearly extending state. In contrast, when a voltage is applied, the respective piezoelectric active portions 53a and 53b try to contract. At this time, both of the piezoelectric active portions 53a and 53b curve inward instead of contracting linearly with mutual binding force. As a result, the slider 52 rotates with respect to the suspension 51. Accordingly, by controlling the voltage applied to the piezoelectric actuator 53, the very small rotation amount of the slider 52 can be controlled, which makes it possible to move the magnetic head 56 to a desired position. Consequently, in the magnetic disk device including this head assembly, fine control of the position of the magnetic head 56 is possible.

When the present inventors actually fabricated the head assembly according to the above embodiment and examined its control characteristic, a satisfactory result was obtained. In the piezoelectric actuator used in this examination, the length of the piezoelectric active portion was set to 0.85 mm, the width of the piezoelectric active portion was set to 0.1 mm, and the number of active layers was set to six. When a voltage of 30 V was applied to a space between the terminals, the displacement amount of the magnetic head became 900 nm. This displacement amount is equal to that of a conventional head assembly described in Patent Document 2. The time required to fabricate the head assembly was reduced to about a half. This is because position adjustment becomes easier and the total number of terminals becomes smaller.

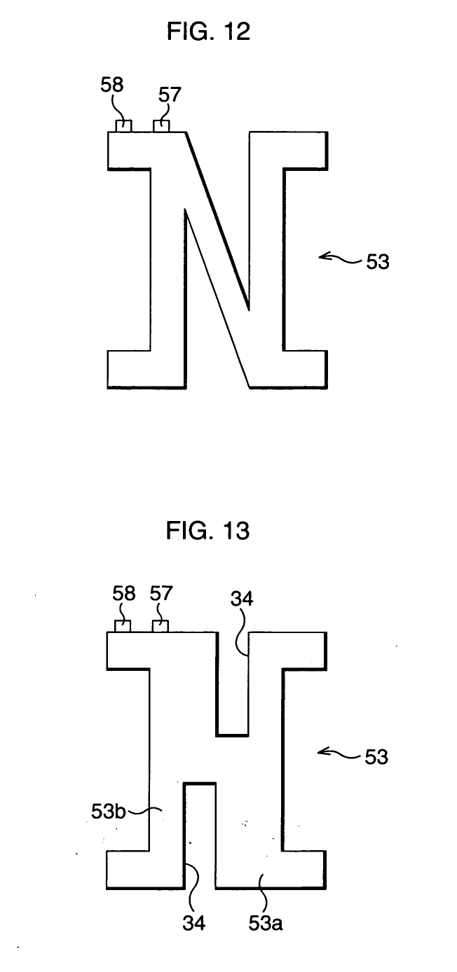

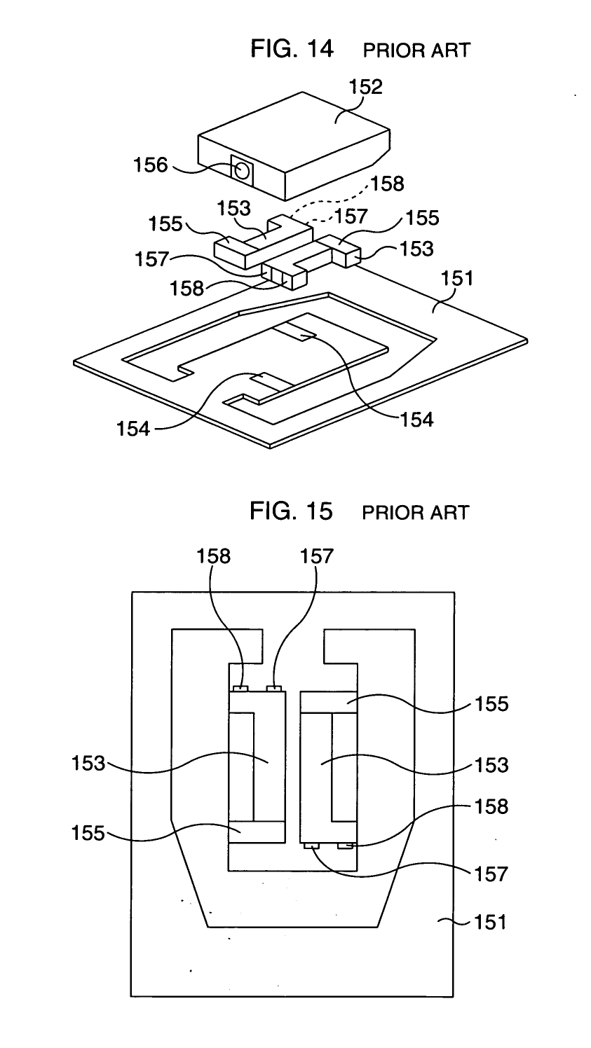

Incidentally, the planar shape of the piezoelectric actuator need not be such an “H” shape as in the above embodiment. For example, as shown in FIG. 12, it may be an “N” shape. Moreover, as shown in FIG. 13, the “H” shape in which the cutouts 34 in two places are displaced from each other is also possible. In other words, it is possible that a width from one end potion to a longitudinal center of each of the piezoelectric active portions 53a and 53b is made wider than a width from the other end portion to the longitudinal center, a wide portion of the piezoelectric active portion 53a faces a narrow portion of the piezoelectric active portion 53b, and a narrow portion of the piezoelectric active portion 53a faces a wide portion of the piezoelectric active portion 53b. In particular, in the planar shape shown in FIG. 13, the cutouts 34 do not face each other, and a portion corresponding to the narrow coupling portion 53c does not substantially exist, so that higher strength can be obtained as compared with the above embodiment.

In the above embodiment, the total number of electrode layers is set to seven and the total number of active layers is set to six, but in the case of use for the head actuator of the magnetic disk device, it is preferable that the total number be of the order of seven to ten. Moreover, for example, it is preferable that the longitudinal length be about 1 mm, and the width be of the order of 100 μm to 500 μm.

If the two piezoelectric active portions are coupled, position adjustment when the head assembly is assembled becomes easier, and hence, the number of terminals need not be two, and may be four as in the related arts. However, in order to facilitate the bonding operation as described above, it is preferable that the number of terminals be two.

Further, in the above embodiment, when the piezoelectric actuator is manufactured, punching is performed after burning, but punching may be performed before burning. Note, however, that in this case, at the time of punching, it is required to use a die which is designed with an allowance for the amount of change of the size of the opening at the time of burning.

Furthermore, in the above embodiment, when the piezoelectric actuator is manufactured, plural piezoelectric actuators are one-dimensionally cut out from the stacked body of green sheets and the like, but piezoelectric actuators may be two-dimensionally cut out using larger green sheets. In other words, in FIG. 2A, FIG. 2B and the like, repetitive patterns may be provided in a top-to-bottom direction of each figure.

According to the present invention, the relative positional relationship between a first and second piezoelectric active portions can be made appropriate without troublesome position adjustment. Therefore, the number of operations when a magnetic disk device is assembled can be reduced, and the time required can be shortened. In particular, the numbers of connecting terminals for a first electrode layer and connecting terminals for a second electrode layer can be one, respectively, which makes it possible to facilitate the bonding operation and shorten the time required for bonding.

The present embodiment is to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A piezoelectric actuator, comprising
a first and second piezoelectric active portions which extend parallel to each other, said first and second piezoelectric active portions being integrated, and each being constructed by alternately stacking first electrode layers connected in common and second electrode layers connected in common with an active layer therebetween.

2. The piezoelectric actuator according to claim 1, wherein said active layer is a piezoelectric ceramic layer.

3. The piezoelectric actuator according to claim 2, wherein said first electrode layers and said second electrode layers contain 5 vol % to 50 vol % of powder having the same composition as that composing said piezoelectric ceramic layer.

4. The piezoelectric actuator according to claim 1, wherein
said first electrode layers in said first piezoelectric active portion and said first electrode layers in said second piezoelectric active portion are connected to each other, and
said second electrode layers in said first piezoelectric active portion and said second electrode layers in said second piezoelectric active portion are connected to each other.

5. The piezoelectric actuator according to claim 4, wherein a connecting terminal for said first electrode layers and a connecting terminal for said second electrode layers are provided only in said first piezoelectric active portion.

6. The piezoelectric actuator according to claim 1, wherein
a width from one end potion to a longitudinal center of each of said first and second piezoelectric active portions is wider than a width from the other end portion to the longitudinal center,
the wider portion of said first piezoelectric active portion faces the narrower portion of said second piezoelectric active portion, and
the narrower portion of said first piezoelectric active portion faces the wider portion of said second piezoelectric active portion.

7. The piezoelectric actuator according to claim 1, wherein said first and second piezoelectric active portions are coupled between their substantially longitudinal central positions.

8. A magnetic disk device, comprising:
a suspension;
a piezoelectric actuator attached to said suspension, said piezoelectric actuator comprising a first and second piezoelectric active portions which extend parallel to each other, said first and second piezoelectric active portions being integrated, and each being constructed by alternately stacking first electrode layers connected in common and second electrode layers connected in common with an active layer therebetween;
a slider attached to said piezoelectric actuator; and
a magnetic head attached to said slider.

9. The magnetic disk device according to claim 8, wherein
said first electrode layers in said first piezoelectric active portion and said first electrode layers in said second piezoelectric active portion are connected to each other, and
said second electrode layer in said first piezoelectric active portion and said second electrode layer in said second piezoelectric active portion are connected to each other.

10. The magnetic disk device according to claim 9, wherein
a connecting terminal for said first electrode layers and a connecting terminal for said second electrode layers are provided only in said first piezoelectric active portion, and
said two connecting terminals are connected to a wiring pattern formed on said suspension.

11. The magnetic disk device according to claim 8, wherein
a width from one end potion to a longitudinal center of each of said first and second piezoelectric active portions is wider than a width from the other end portion to the longitudinal center,
the wider portion of said first piezoelectric active portion faces the narrower portion of said second piezoelectric active portion, and
the narrower portion of said first piezoelectric active portion faces the wider portion of said second piezoelectric active portion.

12. The magnetic disk device according to claim 8, wherein said first and second piezoelectric active portions are coupled between their substantially longitudinal central positions.

13. A driving device, comprising:
a base material;
a piezoelectric actuator attached to said base material, said piezoelectric actuator comprising a first and second piezoelectric active portions which extend parallel to each other, said first and second piezoelectric active portions being integrated, and each being constructed by alternately stacking first electrode layers connected in common and second electrode layers connected in common with an active layer therebetween; and
a driven member attached to said piezoelectric actuator.

14. The drive device according to claim 13, wherein
said first electrode layers in said first piezoelectric active portion and said first electrode layers in said second piezoelectric active portion are connected to each other, and
said second electrode layers in said first piezoelectric active portion and said second electrode layers in said second piezoelectric active portion are connected to each other.

15. The drive device according to claim 14, wherein
a connecting terminal for said first electrode layers and a connecting terminal for said second electrode layers are provided only in said first piezoelectric active portion, and
said two connecting terminals are connected to a wiring pattern formed on said base material.

16. The drive device according to claim 13, wherein
a width from one end potion to a longitudinal center of each of said first and second piezoelectric active portions is wider than a width from the other end portion to the longitudinal center,
the wider portion of said first piezoelectric active portion faces the narrower portion of said second piezoelectric active portion, and
the narrower portion of said first piezoelectric active portion faces the wider portion of said second piezoelectric active portion.

17. The drive device according to claim 13, wherein said first and second piezoelectric active portions are coupled between their substantially longitudinal central positions.
